(19) United States
(12) Patent Application Publication
(10) Pub. No.: US 2017/0120275 A1
(43) Pub. Date: May 4, 2017

(54) DEVICE FOR PACKAGING AND DISPENSING PASTY PRODUCTS

(71) Applicant: LABLABO, JUVIGNY (FR)

(72) Inventors: Patrice PUVILAND, ETEAUX (FR); Jean-Philippe TABERLET, VILLARD (FR)

(21) Appl. No.: 15/317,530

(22) PCT Filed: Apr. 14, 2015
(86) PCT No.: PCT/FR2015/050992

§ 371 Date: Dec. 9, 2016

(30) Foreign Application Priority Data
Jun. 10, 2014 (FR) 14 55234

(51) Int. Cl. B05B 11/00

(52) U.S. Cl. CPC B05B 11/3047; B05B 11/0013; B05B 11/0043; B05B 11/3023

(57) ABSTRACT

The invention relates to a device for packaging and dispensing pasty products, comprising a rigid bottle (1) bearing a pump body (2) mounted on a ring (3) that is fixed in the neck of the rigid bottle (1), comprising a lower peripheral annular stop rib (8) that engages with a clip-fastening collar (12) borne by the pump body in order to fix the pump body (2) to said ring (3), this ring (3) being secured to the neck of a pouch (4) that has a deformable and flexible wall and contains the product to be dispensed, the pump body (2) bearing, above said clip-fastening collar (12), a seal (5) accommodated in an annular groove (6) in the pump body.

According to the invention, at least the stop rib or the clip-fastening collar (8, 12) is provided with at least one vent hole (11).

The invention relates to a device for packaging and dispensing pasty products.

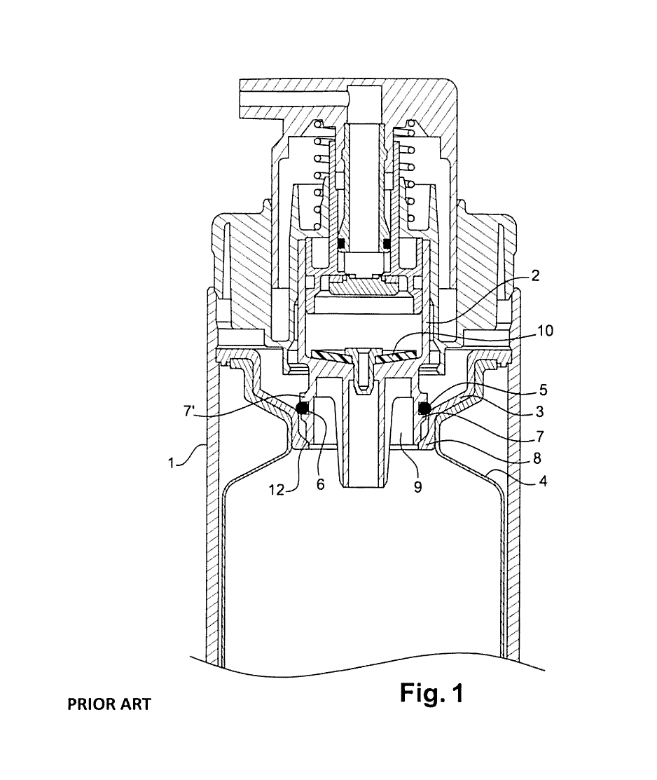

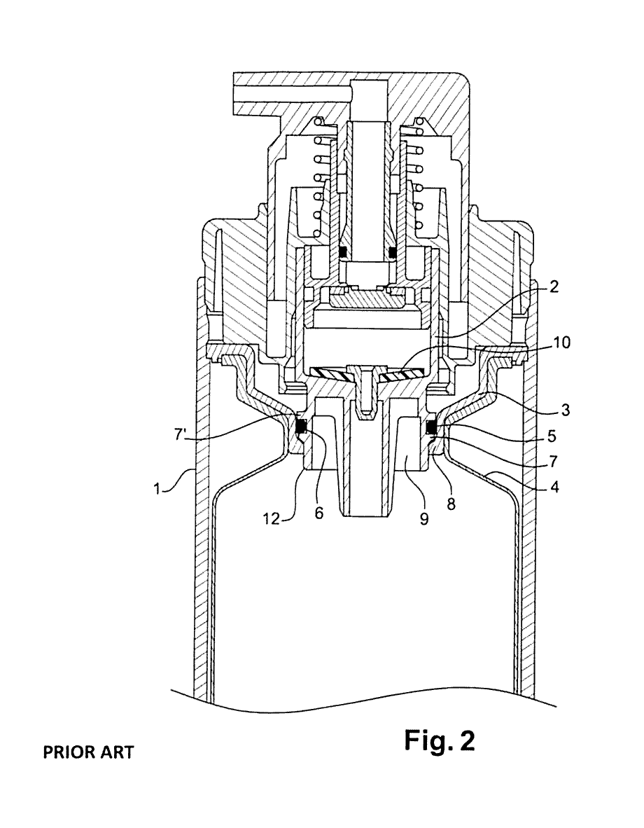

As shown in FIGS. 1 and 2, a known device for packaging and dispensing pasty products comprises a rigid bottle 1 bearing a pump body 2 mounted on a ring 3 that is fixed in the neck of the rigid bottle 1 and is secured to the neck of a pouch 4 that has a deformable and flexible wall and contains the product to be dispensed. The pump body 2 comprises a lower part that is introduced into and clip-fastened in the orifice of the ring 3 and bears a seal 5 accommodated in an annular groove 6 arranged in this lower part and formed by a lower rib 7 and an upper rib 7′ that are borne by this lower part. The ring 3 is furthermore attached to the pouch by welding and clip-fastened in the bottle 1.

This annular groove 6 for accommodating the seal ensures that the latter is held and avoids loss thereof before the pump is fitted in the pouch during final packaging, this seal ensuring that the device is airtight in the long term. It ensures the airtight nature, referred to as “airless”, of the device.

The orientation terms of the type “upper” or “lower” presume here that the bottle is disposed vertically on its base.

In FIG. 1, the pump body is being mounted on the bottle, and in FIG. 2, it is in the mounted position.

The lower end of this pump body comprises a clip-fastening collar 12 which is force-fitted on a lower annular stop rib 8 borne by the orifice of the ring 3, and the seal 5 held in its groove 6 is then slid over this stop rib 8 of the ring, along the peripheral surface of the ring 3, until the lower rib 7 forming the groove 6 of the seal butts against the stop rib 8 of the ring.

Such a known arrangement raises the following technical problem.

The pouch 4 is filled before the body of the pump is mounted and, in general, there is a certain volume of air above the surface of the product in the pouch. As a result, a random number of initial pumping operations are required when the device is used for the first time, in order to evacuate this air. These initial pumping operations are detrimental to optimum ease and effectiveness of use.

In order to avoid these initial pumping operations when the device is used for the first time, the pouch 4 is intended to be filled to the maximum with packaged product before the body of the pump is mounted, in order fill the central hollow shaft 9 of the pump body, through which the product is evacuated via the lower valve 10 of the pump, to the maximum.

However, it is then found that product passes into the space between the ring 3 and the lower part of the body of the pump and, more specifically, above the stop rib 8 borne by the orifice of the ring 3. During the mounting of the pump body, the product introduced is then trapped between this stop rib 8 borne by the orifice of the ring 3 and the seal 5 which, accommodated in its groove 6, cannot deform, as illustrated in FIG. 1. Being incompressible, this trapped product forms a rigid zone which prevents the continuation of the mounting of the body of the pump into the clip-fastened position shown in FIG. 2.

The invention solves this problem by way of an improvement that is particularly simple to manufacture without reducing the retention force of the pump body on the ring.

To this end, the invention proposes a device for packaging and dispensing pasty products, comprising a rigid bottle bearing a pump body mounted on a ring that is fixed in the neck of the rigid bottle, comprising a lower peripheral annular stop rib that engages with a clip-fastening collar borne by the pump body in order to fix the pump body to said ring, this ring being secured to the neck of a pouch that has a deformable and flexible wall and contains the product to be dispensed, the pump body bearing, above said clip-fastening collar, a seal accommodated in an annular groove in the pump body, characterized in that at least the stop rib or the clip-fastening collar is provided with at least one vent hole.

According to a preferred embodiment, said vent hole is arranged in said clip-fastening collar borne by the lower part of the pump body.

Advantageously, said vent hole consists of a slot arranged in said rib or said collar.

Preferably, said rib or said collar comprises at least two vent holes distributed around the periphery thereof.

Preferably, said seal is compressed against a cylindrical wall of said ring adjacent to said clip-fastening collar, in the mounted position.

Advantageously, said annular groove is formed by at least one lower rib butting against said lower peripheral annular stop rib, in the mounted position.

Preferably, the device is airtight in the manner referred to as “airless”.

The invention is described in more detail below with the aid of a figure showing a preferred embodiment of the invention.

FIGS. 1 and 2 are thus views in vertical section of a device for packaging and dispensing pasty products according to the prior art.

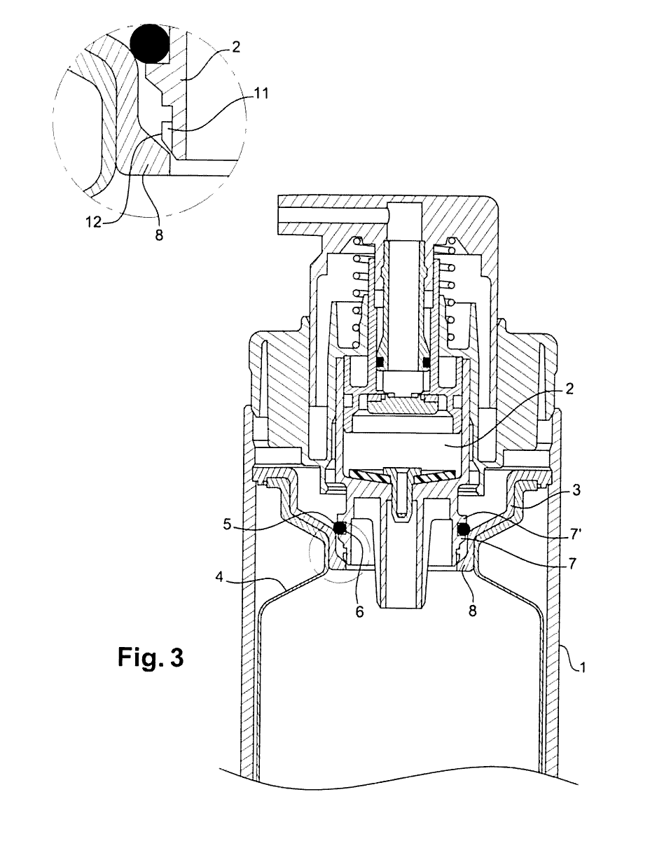

FIG. 3 is a view in vertical section of a device for packaging and dispensing pasty products according to the invention, with an associated detail view and in the mounting position.

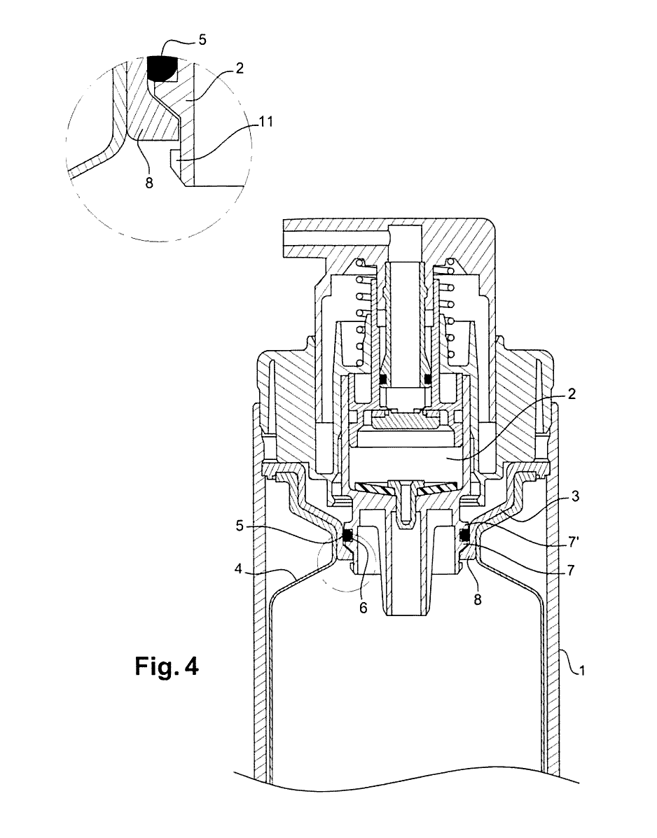

FIG. 4 is a view in vertical section of a device for packaging and dispensing pasty products according to the invention, with an associated detail view and in the mounted position.

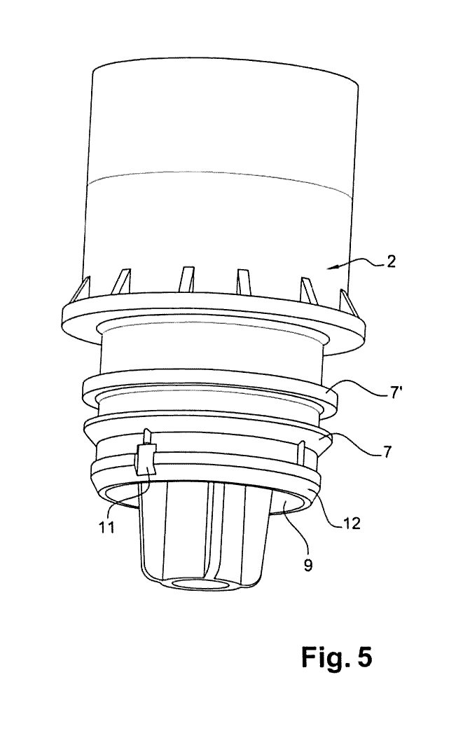

FIG. 5 is a perspective view of a pump body of a device for packaging and dispensing pasty products according to the invention.

As shown in FIGS. 3 and 4, according to the invention, a device for packaging and dispensing pasty products comprises a rigid bottle 1 bearing a pump body 2 mounted on a ring 3 that is fixed in the neck of the rigid bottle 1, comprising a lower peripheral annular stop rib 8 that engages with a clip-fastening collar 12 borne by the pump body, and is secured to the neck of a pouch that has a flexible and deformable wall 4 and contains the product to be dispensed.

The pump body 2 comprises a lower part that is introduced into and clip-fastened in the orifice of the ring 3 and bears an O-ring seal 5 accommodated in an annular groove 6 arranged in this lower part and formed by a lower rib 7 and an upper rib 7′ that are borne by this lower part.

At least the stop rib or the clip-fastening collar 8, 12 is provided with at least one vent hole 11.

According to the embodiment shown, there are two vent holes 11 that are distributed around the periphery of the rib and are arranged in the clip-fastening collar 12 borne by the lower part of the pump body.

As can be seen more clearly in FIG. 5, each vent hole 11 consists of a slot of calibrated size arranged in the clip-fastening collar 12.

By virtue of the invention, when product introduced into the space between the ring 3 and the lower part of the body of the pump and, more specifically, above the stop rib 8 borne by the orifice of the ring 3, is trapped, during mounting, between this stop rib 8 and the lower rib 7 forming the groove 6 of the seal, as illustrated in FIG. 3, it can be evacuated into the pouch 4 through the vent holes 11 during the downward pressure of the lower rib 7 of the groove on this product, which is thus reintroduced into the pouch 4. At the end of mounting, the lower rib 7 of the groove 6 of the seal butts against the stop rib 8 borne by the orifice of the ring 3, by means of two surfaces of identical inclination which block flat surfaces against one another by abutment.

It is thus possible to fill the pouch 4 and the central hollow shaft 9 of the pump body to the maximum with packaged product before the body of the pump is mounted, and thus to control the number of initial pumping operations when the device is used for the first time.

1. Device for packaging and dispensing pasty products, comprising:
a rigid bottle bearing a pump body mounted on a ring that is fixed in the neck of the rigid bottle, having a lower peripheral annular stop rib that engages with a clip-fastening collar borne by the pump body in order to fix the pump body to said ring, this ring being secured to the neck of a pouch that has a deformable and flexible wall and contains the product to be dispensed, the pump body bearing, above said clip-fastening collar, a seal accommodated in an annular groove in the pump body, characterized in that at least the stop rib or the clip-fastening collar is provided with at least one vent hole.

2. Device according to claim 1, wherein said vent hole is arranged in said clip-fastening collar borne by the lower part of the pump body.

3. Device according to claim 1, wherein said vent hole is a slot arranged in said rib or said collar.

4. Device according to claim 1, wherein said rib or said collar comprises at least two vent holes distributed around the periphery thereof.

5. Device according to claim 1, wherein said seal is compressed against a cylindrical wall of said ring adjacent to said clip-fastening collar, in the mounted position.

6. Device according to claim 1, wherein said annular groove is formed by at least one lower rib butting against said lower peripheral annular stop rib, in the mounted position.

7. Device according to claim 1, wherein said device is airtight or airless.
